(19) United States
(12) Patent Application Publication
(10) Pub. No.: US 2025/0355734 A1
(43) Pub. Date: Nov. 20, 2025

(54) ENABLING COMPUTATIONAL STORAGE OPERATIONS THROUGH LEGACY CLIENT STORAGE INTERFACES

(71) Applicant: INTERNATIONAL BUSINESS MACHINES CORPORATION, ARMONK, NY (US)

(72) Inventors: Daniel Waddington, Morgan Hill, CA (US); Guy Margalit, Tel Aviv (IL)

(21) Appl. No.: 18/666,118

(22) Filed: May 16, 2024

(51) Int. Cl. G06F 9/54

(52) U.S. Cl. CPC G06F 9/544

(57) ABSTRACT

Provided are techniques for enabling computational storage operations through legacy client storage interfaces. A front-end storage command for an object is received, where the object comprises a storage unit identifier and data. A storage unit is identified based on the identifier. One or more computational storage operations are identified that are associated with the storage unit and with a type of the front-end storage command. The one or more computational storage operations are converted into one or more back-end storage commands. The front-end storage command and the one or more backend storage commands are executed.

### BACKGROUND

Embodiments of the invention relate to enabling computational storage operations through legacy client storage interfaces (e.g., Application Programming Interfaces (APIs)).

Today, storage systems fall into three categories: block, file, and object. File and object may be described as abstractions used directly by the application, through a file API or an object API.

File APIs, such as that defined by the Portable Operating System Interface (POSIX®) standard, allow applications to manage and manipulate files. (POSIX is a registered trademark of Institute of Electrical and Electronics Engineers (IEEE) in the United States and/or other countries.) File abstractions generally allow file and directory management, full or partial file reads, full or partial writes in-place. Under the hood, some filesystems (e.g., BTRFS) provide copy-on-write semantics to maximize efficiency by avoiding some replication of data. File abstractions also allow for file and directory access control.

Object APIs typically do not support in-place writes; instead, they support atomic full-object writes. Instead of directories, object APIs employ the concept of buckets. Object APIs allow operations on objects such as: store object (put), multi-part upload of object, read object (get) or partial objects (range get), encryption of data at rest, versioning, and access control.

Currently, the file APIs and the object APIs are used to perform storage operations.

### SUMMARY

In accordance with certain embodiments, a computer program product comprising a computer readable storage medium having program code embodied therewith is provided, where the program code is executable by at least one computer processor to perform operations for enabling computational storage operations through legacy client storage interfaces. In such embodiments, a front-end storage command for an object is received, where the object comprises a storage unit identifier and data. A storage unit is identified based on the identifier. One or more computational storage operations are identified that are associated with the storage unit and with a type of the front-end storage command. The one or more computational storage operations are converted into one or more back-end storage commands. The front-end storage command and the one or more backend storage commands are executed.

In accordance with other embodiments, a computer system comprises one or more computer processors, one or more computer-readable memories and one or more computer-readable, tangible storage devices; and program instructions, stored on at least one of the one or more computer-readable, tangible storage devices for execution by at least one of the one or more computer processors via at least one of the one or more memories, to perform operations for enabling computational storage operations through legacy client storage interfaces. In such embodiments, a front-end storage command for an object is received, where the object comprises a storage unit identifier and data. A storage unit is identified based on the identifier. One or more computational storage operations are identified that are associated with the storage unit and with a type of the front-end storage command. The one or more computational storage operations are converted into one or more back-end storage commands. The front-end storage command and the one or more backend storage commands are executed.

In accordance with yet other embodiments, a computer-implemented method comprising operations is provided for enabling computational storage operations through legacy client storage interfaces. In such embodiments, a front-end storage command for an object is received, where the object comprises a storage unit identifier and data. A storage unit is identified based on the identifier. One or more computational storage operations are identified that are associated with the storage unit and with a type of the front-end storage command. The one or more computational storage operations are converted into one or more back-end storage commands. The front-end storage command and the one or more backend storage commands are executed.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a deployment architecture for a storage interface in accordance with certain embodiments.

FIG. 3 illustrates a deployment architecture for an object interface in accordance with certain embodiments.

FIG. 4 illustrates a deployment architecture for a file interface in accordance with certain embodiments.

FIG. 5 illustrates a flow of operations for executing a front-end storage command with one or more computational storage operations in accordance with certain embodiments.

FIG. 6 illustrates a mapping for an object key and a filename in accordance with certain embodiments.

FIG. 7 illustrates a table of example computational storage operations in accordance with certain embodiments.

FIG. 8 illustrates different types of key-level computational storage operations in accordance with certain embodiments.

FIG. 9 illustrates a conceptual view of active storage in accordance with certain embodiments.

FIG. 10 illustrates an example of a multi-object operation in accordance with certain embodiments.

FIG. 11 illustrates, in a flowchart, operations for identifying and executing computational storage operations in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

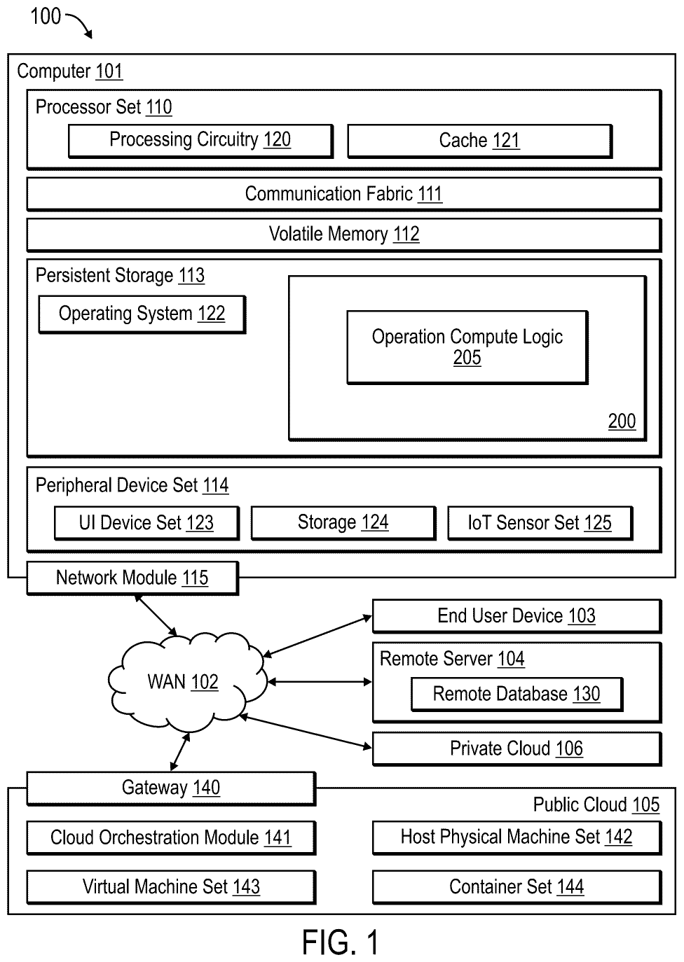

Computing environment 100 of FIG. 1 contains an example of an environment for the execution of at least some of the computer code involved in performing the inventive methods, such as operation compute logic 205 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing. In certain embodiments, the computer processor comprises a Graphics Processing Units (GPU).

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

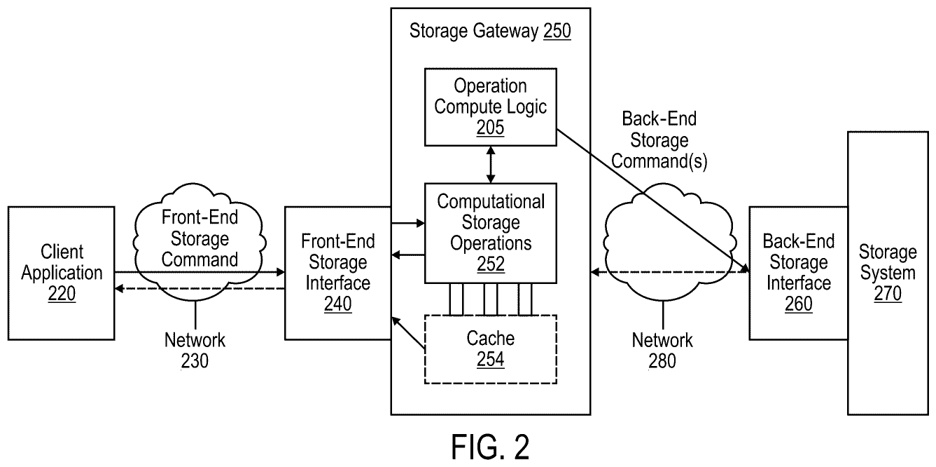

FIG. 2 illustrates a deployment architecture for a storage interface in accordance with certain embodiments. In FIG. 2, a client application 220 issues a front-end storage command (e.g., a read operation or a write operation), via a network 230, to a front-end storage interface 240 of a storage gateway 250. The storage gateway 250 includes operation compute logic 205, computational storage operations 252, and a cache 254. The operation compute logic 205 identifies one or more computational storage operations 252 based on a storage unit identified using the front-end storage command from the client application 220. Then, the operation compute logic 205 generates one or more back-end storage commands that support the one or more computational storage operations 252 and issues the one or more back-end storage commands, via a network 280, to the back-end storage interface 260 of the storage system 270.

Once the front-end storage command and the back-end storage commands have been executed, the distributed object store 270 may route information via the back-end storage interface 260 to the storage gateway 250, and the information is passed back to the client application 220 via the front-end storage interface 240. In certain embodiments, the information is status information about whether the front-end storage command was executed was executed successfully, a description of which computational storage operations 252 were executed for the back-end storage commands, etc. In certain embodiments, the front-end storage interface 240 is an object interface, while in other embodiments, the front-end storage interface 240 is a file interface.

In certain embodiments, the back-end storage interface 260 is an object interface, while in other embodiments, the back-end storage interface 260 is a file interface.

In certain embodiments, the storage system 270 is co-located with the storage gateway 250. In certain embodiments, the storage gateway 250 and the storage system 270 are connected by a data bus, a distributed network (e.g., Ethernet) or a local network (e.g., Peripheral Component Interconnect (PCI) express) instead of the network 280.

With embodiments, the computational storage operations 252 reside in the storage gateway 250, instead of on the storage system 270. The computational storage operations 252 residing on the storage gateway 250 have local visibility of the data that they are operating on. For example, the complete contents (data) of an object may be loaded or received into cache (or other memory) in the storage gateway 250, and the operation compute logic 205 may be executed on the data. In storage of the storage system 270, the data may be striped across multiple data nodes, and so executing the back-end storage commands on the storage data nodes may not be viable due to an incomplete view of the data. Furthermore, operating outside of the storage system 270 allows for separation of security domains.

In certain embodiments, the storage gateway 250 has the architecture of computer 101. In certain embodiments, the storage system 270 has the architecture of computer 101.

Embodiments overload existing front-end and back-end storage command semantics (e.g., read (get) and write (put) semantics) of the storage interface 240, 260 (e.g., an existing file interface or an existing object interface) (e.g., of the POSIX filesystem)) without modifying syntactic elements of the protocol for executing the front-end and back-end storage commands. That is, embodiments overload storage command semantics on a legacy client storage interface (i.e., a front-end storage interface). Embodiments extend the storage interface 240, 260 (e.g., the existing file interface or the existing object interface) with computational storage operations without modification of the client application 220.

With embodiments, the operation compute logic 205 implicitly creates multiple derived data elements in response to front-end storage commands (e.g., to read and write data from the storage system 270) from the client application.

The operation compute logic 205 of the storage gateway 250 transparently performs the computational storage operations that create/derive and transform data that is stored on a traditional storage back-end (e.g., the storage system 270).

In certain embodiments, the operation compute logic 205 extracts data from a single object write front-end storage command and inherently performs new back-end storage commands, which are derived from the single object write, on multiple other objects that reside within the same storage system.

In addition, embodiments add implicit data creation/derivation back-end storage commands to existing storage APIs. Also, embodiments enable use of both ingress and egress type front-end storage commands to perform computational storage operations when data enters and leaves the storage system 270. Moreover, embodiments use time-based and/or other external events to trigger computational storage operations (e.g., age-out, versioning) on data in the storage system 270.

The operation compute logic 205 extends the traditional file/object paradigms to support transparent transformation and generation of data according to a requested storage unit identifier (e.g., a key identifier). For example, if an object is placed into a specific bucket named “alpha format” (e.g., a column-oriented first format), then the operation compute logic 205 transparently transforms any data that is not in the alpha format (e.g., in a text-based second format) into the alpha format. In this manner, embodiments expand on the notion of “computational storage” beyond traditional compression and encryption to include domain-specific data operations.

In certain embodiments, a storage unit listing (e.g., a directory listing or a bucket listing) is used as the client application mechanism to discover the computable functionality (i.e., the computational storage operations) of the storage system. That is, instead of the client application acquiring knowledge of “hidden” or “documented” computational storage operations out of band, the storage system provides the list of computational storage operations that are available to invoke using, for example, readdir/list-objects on the target directory/bucket, which responds with a “virtual” list of keys/names that may be used to invoke those computational storage operations.

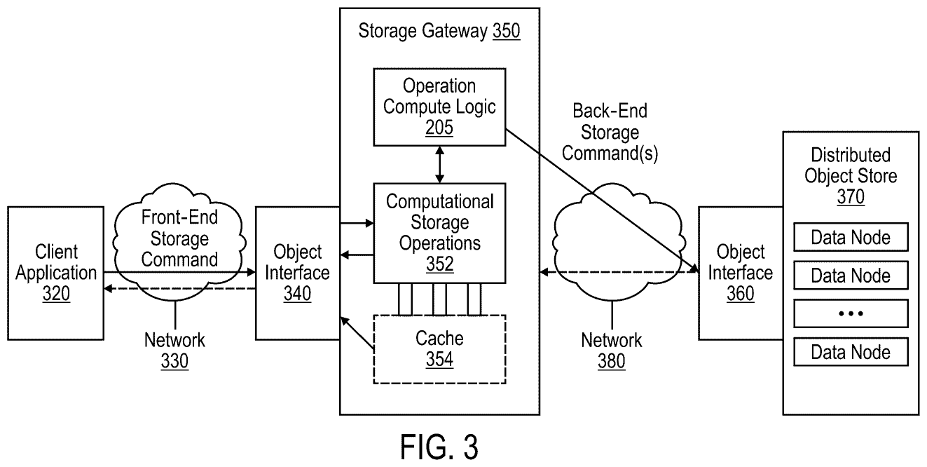

FIG. 3 illustrates a deployment architecture for an object interface in accordance with certain embodiments. In FIG. 3, a client application 320 issues a front-end storage command (e.g., a read operation or a write operation), via a network 330, to an object interface 340 of a storage gateway 350. The storage gateway 350 includes operation compute logic 305, computational storage operations 352, and a cache 354. The operation compute logic 305 identifies one or more computational storage operations 352 based on a storage unit identified using the front-end storage command from the client application 320. Then, the operation compute logic 305 generates one or more back-end storage commands that support the one or more computational storage operations 352 and issues the one or more back-end storage commands, via a network 380, to the back-end storage interface 360 of the storage system 370.

Once the front-end storage command and the back-end storage commands have been executed, the distributed object store 370 may route information via the back-end storage interface 360 to the storage gateway 350, and the information is passed back to the client application 320 via the front-end storage interface 340. In certain embodiments, the information is status information about whether the front-end storage command was executed was executed successfully, a description of which computational storage operations 352 were executed for the back-end storage commands, etc.

In certain embodiments, the object interfaces 340, 360 on the front-end of the storage gateway 350 and the back-end distributed object store 370 are the same object interface. The storage gateway 350 is permitted (e.g., by a secure access control) to access the distributed object store 370 on behalf of the client application 320.

In certain embodiments, the storage system 370 is co-located with the storage gateway 350. In certain embodiments, the storage gateway 350 and the storage system 370 are connected by a data bus, a distributed network (e.g., Ethernet) or a local network (e.g., Peripheral Component Interconnect (PCI) express) instead of the network 380.

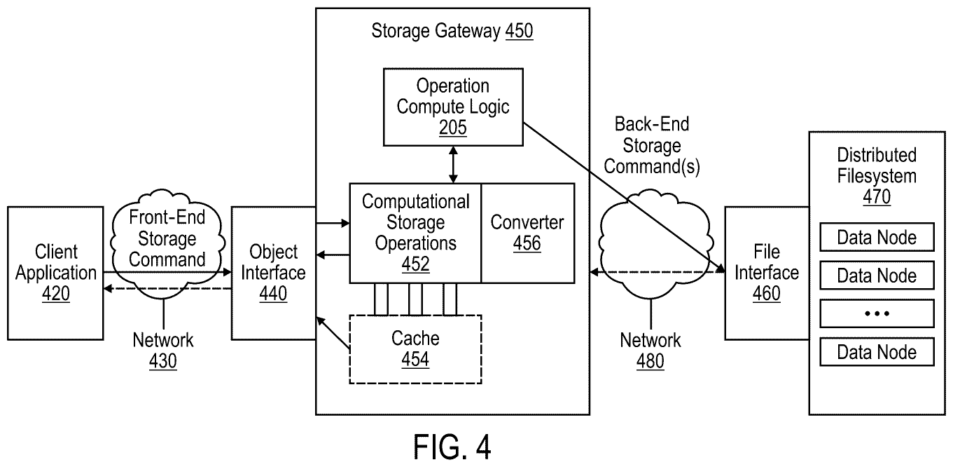

FIG. 4 illustrates a deployment architecture for a file interface in accordance with certain embodiments. In FIG. 4, a client application 420 issues a front-end storage command (e.g., a read operation or a write operation), via a network 430, to an object interface 440 of a storage gateway 450. The storage gateway 450 includes operation compute logic 205, computational storage operations 452, a cache 454, and a converter 456. The operation compute logic 405 identifies one or more computational storage operations 452 based on a storage unit (e.g., file or object) identified using the front-end storage command from the client application 420. Then, the operation compute logic 405 generates one or more back-end storage commands that support the one or more computational storage operations 452 and issues the one or more back-end storage commands, via a network 480, to the back-end storage interface 460 of the distributed filesystem 470.

Once the front-end storage command and the back-end storage commands have been executed, the distributed object store 470 may route information via the back-end storage interface 460 to the storage gateway 450, and the information is passed back to the client application 420 via the front-end storage interface 440. In certain embodiments, the information is status information about whether the front-end storage command was executed was executed successfully, a description of which computational storage operations 452 were executed for the back-end storage commands, etc.

In certain embodiments, the front-end object interface 440 is different from the back-end file interface 460. This allows an object-based front-end with a file-based back-end and vice-versa. In such embodiments, the converter 456 converts functions (e.g., computational storage operations) to map between the object and file domains.

In certain embodiments, the storage system 470 is co-located with the storage gateway 450. In certain embodiments, the storage gateway 450 and the storage system 470 are connected by a data bus, a distributed network (e.g., Ethernet) or a local network (e.g., Peripheral Component Interconnect (PCI) express) instead of the network 480.

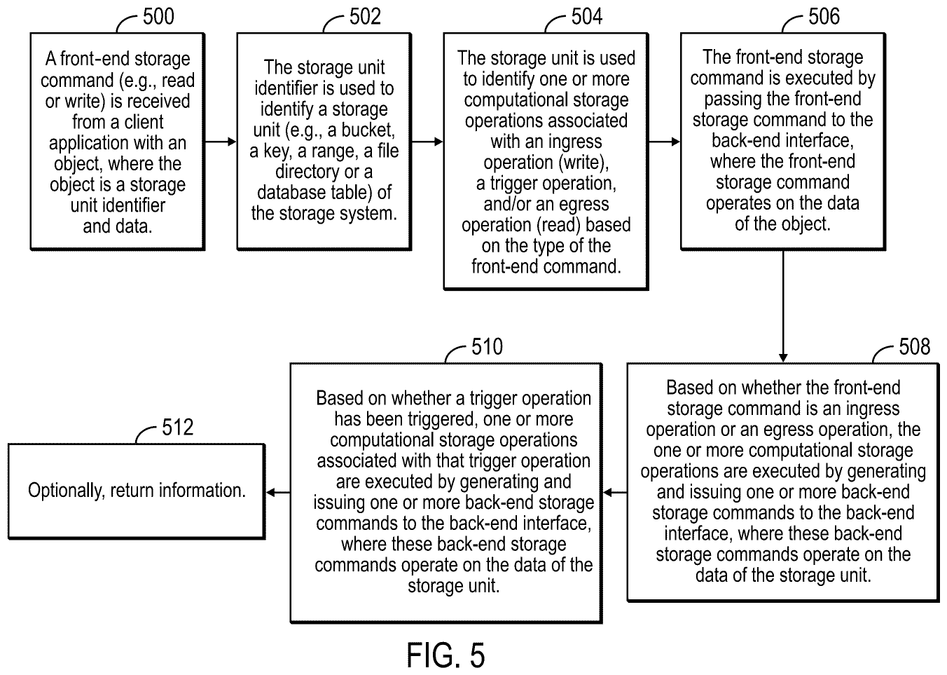

FIG. 5 illustrates a flow of operations for executing a front-end storage command with one or more computational storage operations in accordance with certain embodiments. The operation compute logic 205 receives a front-end storage command (e.g., a read or a write) from a client application with an object, where the object is a storage unit identifier and data (i.e., a storage unit identifier-data pair) (block 500). That is, the object is made up of a storage unit identifier portion and a data portion. The front-end storage command may be referred to as an input storage command or a first storage command. The operation compute logic 205 uses the storage unit identifier to identify a storage unit (e.g., a bucket, a key, a range, a file directory, a database table etc.) of the storage system (block 502). The operation compute logic 205 uses the storage unit to identify one or more computational storage operations associated with an ingress operation (write), a trigger operation (trigger-based), and/or an egress operation (read)) (504) based on the type of the front-end command. In certain embodiments, the one or more computational storage operations are associated with the storage unit and with the type of the front-end storage command, where the type is: ingress operation (write) and/or egress operation (read). In addition, receiving the front-end storage command may be a trigger for performing a trigger operation. Also, there may be other triggers for performing the trigger operation.

The operation compute logic 205 executes the front-end storage command by passing the front-end storage command to the back-end interface, where the front-end storage command operates on the data (i.e., the data value) of the object (506).

Based on whether the front-end storage command is an ingress operation (write) or an egress operation (read), the operation compute logic 205 executes one or more computational storage operations by generating and issuing one or more back-end storage commands to the back-end interface and storage system, where these back-end storage commands operate on the data (i.e., the value) of the storage unit (block 508). That is, if the type of the front-end storage command from the client application is an ingress (write) operation, then the operation compute logic 205 executes the computational storage operations associated with the ingress operation. If the type of the front-end storage command from the client application is an egress (read) operation, then the operation compute logic 205 executes the computational storage operations associated with the egress operation. Generating the one or more back-end storage commands may be described as converting the one or more computational storage operations into the one or more back-end storage commands (e.g., by mapping the one or more computational storage operations to the one or more back-end storage commands based on a mapping). The one or more back-end storage commands may be referred to as output storage commands (output by the operation compute logic 205) or second storage commands.

In addition, based on whether a trigger operation has been triggered, the operation compute logic 205 executes the one or more computational storage operations associated with that trigger operation by generating and issuing one or more back-end storage commands to the back-end interface and storage system, where these back-end storage commands operate on the data of the storage unit (block 510). Generating the one or more back-end storage commands may be described as converting the one or more computational storage operations into the one or more back-end storage commands.

Optionally, the storage system may return information to the client application, such as status information about whether the front-end storage command was executed successfully, a description of which computational storage operations were executed for the back-end storage commands, etc. (block 512).

In certain embodiments, when new data is derived and stored in the storage system, when the client application issues a read storage command for a storage unit, the storage system returns the data in that storage unit, which includes the new, derived data. In this manner, embodiments derive new data that may be accessed by the client application without modifying the client application and the storage interfaces.

In certain embodiments, computational storage operations are associated with specific buckets, keys, ranges, file directories, database tables, etc. Initially, a front-end storage command is received with a data object, and the data object is a storage unit identifier-data pair. The operation compute logic 205 identifies computational storage operations to be executed based on whether the storage operation is an ingress operation or an egress operation and based on the identifier.

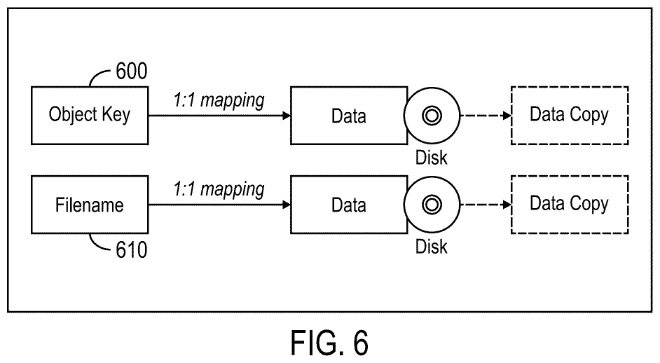

What is common to both file APIs and object APIs, is the concept of a “unit of data”, i.e., a file or object. A storage system 270 ensures that these units of data are managed according to some policy and are made durable and in some solutions highly available (e.g., with replica copies of the data stored in different storage systems. Directories and buckets are used to make collections of related data (in a hierarchical manner), while filenames and object keys are used to identify units of data. There is typically a direct one-to-one mapping between file and object identifiers and the associated unit of data that resides on one or more storage devices (e.g., Hard Disk Drive (HDD), Solid-State Drive (SSD) or other media device). When data is placed in a storage system, the data typically is not modified other than for (in some systems) compression and/or encryption. FIG. 6 illustrates a mapping for an object key 600 and a filename 610 in accordance with certain embodiments.

Merely to enhance understanding of embodiments, an object-based (key-value) storage system example is provided. However, other embodiments include filesystems, databases, and other storage systems.

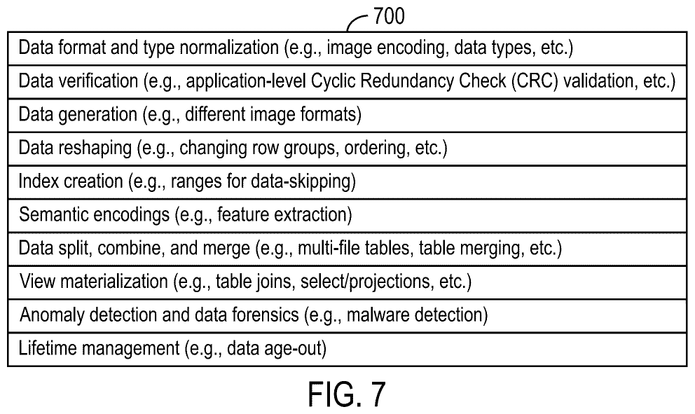

FIG. 7 illustrates a table 700 of example computational storage operations in accordance with certain embodiments. For example, a data format and type normalization computational storage operation may normalize the data from a first data format to a second data format and/or convert from a first type to a second type.

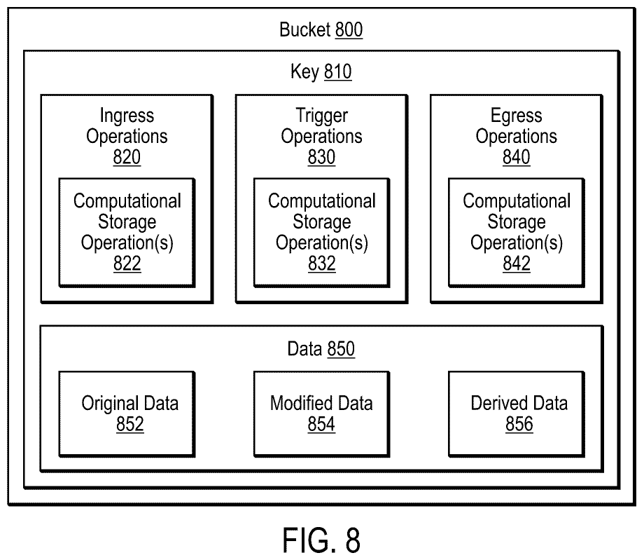

FIG. 8 illustrates different types of key-level computational storage operations in accordance with certain embodiments. For a particular bucket 800 and a particular key 810, the computational storage operations may be described as belonging to one of three categories: ingress operations 820 with one or more associated computational storage operations 822, egress operations 830 with one or more associated computational storage operations 832, and trigger operations 840 with one or more associated computational storage operations 842. The one or more associated computational storage operations 822 of the ingress operations 820 are those that are performed when data is written into the storage system (e.g., execution of an object put operation) creating a new object as opposed to modifying an existing object. The one or more associated computational storage operations 832 of the egress operations 830 are those that are performed when an object is read/retrieved from the storage system. The one or more associated computational storage operations 842 of the trigger operations 840 are those that are executed on some implicit trigger event, such as reaching a certain object age or some other operations on the object or bucket. The computational storage operations operate on data 850 of the storage unit, which is key 810 in this example. The data 850 includes original data 852, modified data 854, and derived data 846. The modified data 854 may be original data 852 that has been modified or derived data 846 that has been generated. The derived data 846 may be data that has been generated using a computational storage operation that operates on the original data 852 or the modified data 854.

The computational storage operations may be attached to data at the bucket level, the individual object level, the file level, the directory level, etc. In certain embodiments, the operation compute logic 205 may be provided as part of “stock” computational storage operations or may be provided by the system administrator/user allowing for custom defined computational storage operations.

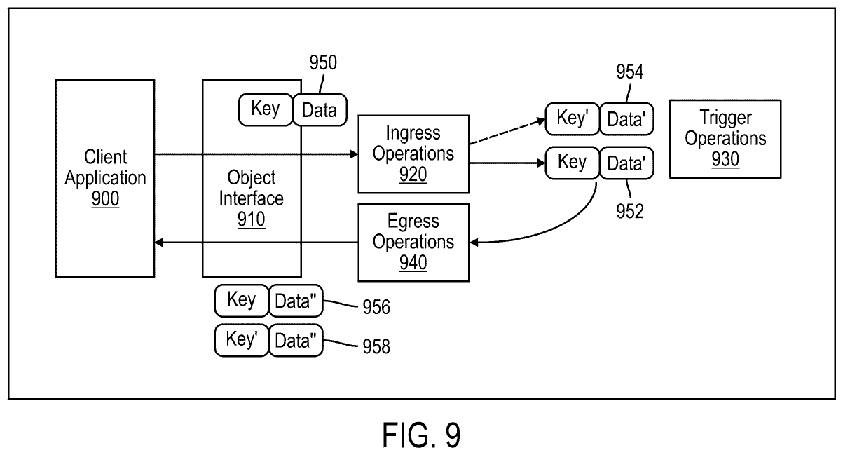

FIG. 9 illustrates a conceptual view of active storage in accordance with certain embodiments. In the example of FIG. 9, the storage unit identifier and the data are a key-data pair (i.e., a storage unit identifier (“key”)-data (“data”) pair). In FIG. 9, a client application 900 sends, through the object interface 910, a key-data pair 950 with an ingress operation 920. The operation compute logic 205 may execute the ingress operation 920 to generate both a key-data′ pair 952 and a new key′-data′ pair 954. For the key-data′ pair 952, the data value of data′ has been modified with respect to the data value of data of the key-data pair 950. For the key′-data′ pair 954, both the key value of key′ and the data value of data″ have been modified with respect to the key value of key and the data value of data of the key-data pair 950.

For the data provided by the user in the key-data pair 950, the operation compute logic 205 may modify existing data in the storage system (e.g., normalize types) and/or derive new data in the storage system (e.g., create an index/encoding or change format).

Moreover, the operation compute logic 205 may perform trigger operations 930 on the key-data′ pair 952 and/or the key′-data′ pair 954.

The operation compute logic 205 may also perform an egress operation 940 on the key-data′ pair 952 to generate both a key-data″ pair 956 and a key′-data″ pair 958. For the key-data″ pair 956, the data value of data″ has been modified with respect to the data value of data′ of the key-data′ pair 952. For the key′-data″ pair 958, both the key value of key′ and the data value of data″ have been modified with respect to the key value of key and the data value of data′ of the key-data′ pair 952.

The key-data pairs generated by the computational storage operations 920, 930, 940 may be maintained as objects or files in the storage system.

The following example is provided to enhance understanding of embodiments. In this example, the client application 900 PUTs (writes) a Beta_Format object 950 into a bucket X corresponding to a specific database table. The storage state for this example initially is:

$$Key = X / CUSTOMER , Data = Beta\_Format - text$$

An ingress operation 920, which is configured for bucket X, examines the data of original key-data pair 950, transforms the original Beta_Format value into multiple Alpha_Format slices, and stores these derived objects (i.e., the slices) in a parallel bucket, X-ALPHA_FORMAT. After deriving the Alpha_Format object, the original Beta_Format value is compressed with a lossless compression technique LZ4.

The storage state at this stage is:

$$Key = X / CUSTOMER , Data = Beta\_Format - LZ 4$$

$$Key = X - ALPHA\_FORMAT / CUSTOMER - 1 , Data = Alpha\_Format$$

$$Key = X - ALPHA\_FORMAT / CUSTOMER - 2 , Data = Alpha\_Format$$

$$Key = X - ALPHA\_FORMAT / CUSTOMER - 3 , Data = Alpha\_Format$$

The client application 900 may now access the Alpha_Format data from the parallel bucket, X-ALPHA_FORMAT.

In addition, when the client application 900 does a GET on X/CUSTOMER to retrieve the original Beta_Format value, the storage gateway decompresses Beta_Format-LZ4 back into plain Beta_Format text.

In certain embodiments, when adding a new data object (e.g., set of rows/columns in alpha format) to a given bucket, the incoming data is opened and the corresponding rows inserted into the correct partition according to some range criteria (or alternatively hash) on the given partition field. Thus, the operation compute logic 205 is taking a PUT operation on a bucket and overloading the semantics to mean dismantle the incoming data and merge into existing sorted/partitioned table data.

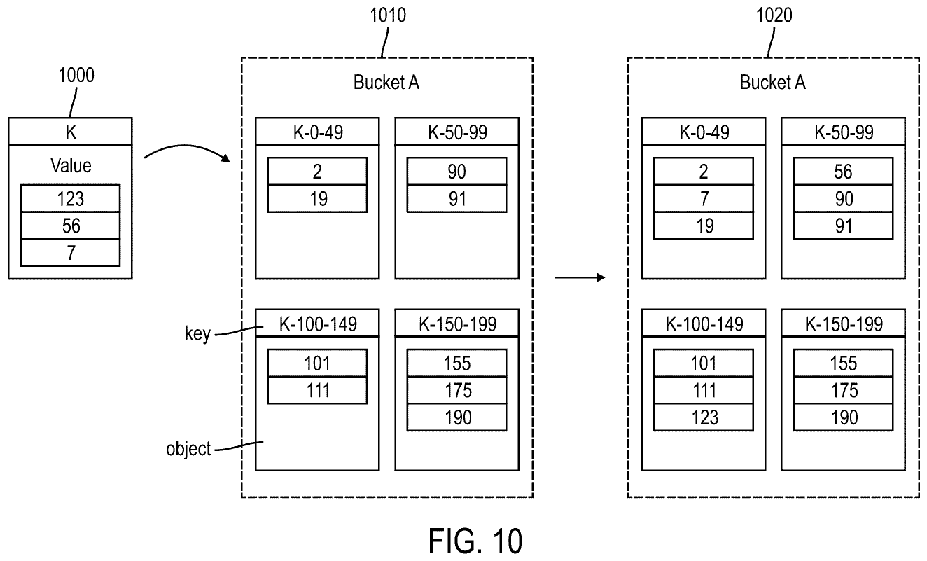

FIG. 10 illustrates an example of a multi-object operation in accordance with certain embodiments. In FIG. 10, an object 1000 containing records/table rows with partition values 123, 56, and 7 is first PUT as an object (e.g., in alpha format) into initial bucket A 1010. The operation compute logic 205 then opens the value data and iterates the rows, inserting them into the appropriate partition in the correct order resulting in bucket A 1020.

In certain embodiments, to configure and load operations into the storage system, embodiments use existing protocols as-is, so that client protocol libraries are not modified. This may achieved either by writing configuration scripts/data to either “special” objects/buckets that are attached to configuration computational storage operations or by using the existing protocol's metadata or custom data fields (e.g., extended file attributes (xattr), object's user-defined metadata, Hypertext Transfer Protocol (HTTP) headers, object's tagging, etc.).

The operation compute logic 205 extends the semantics behind legacy interfaces and allows the derivation of new data through transformation and other data processing. This reduces the footprint of data (through on demand derivation) and increases the usability of the data by deriving forms for different use-cases.

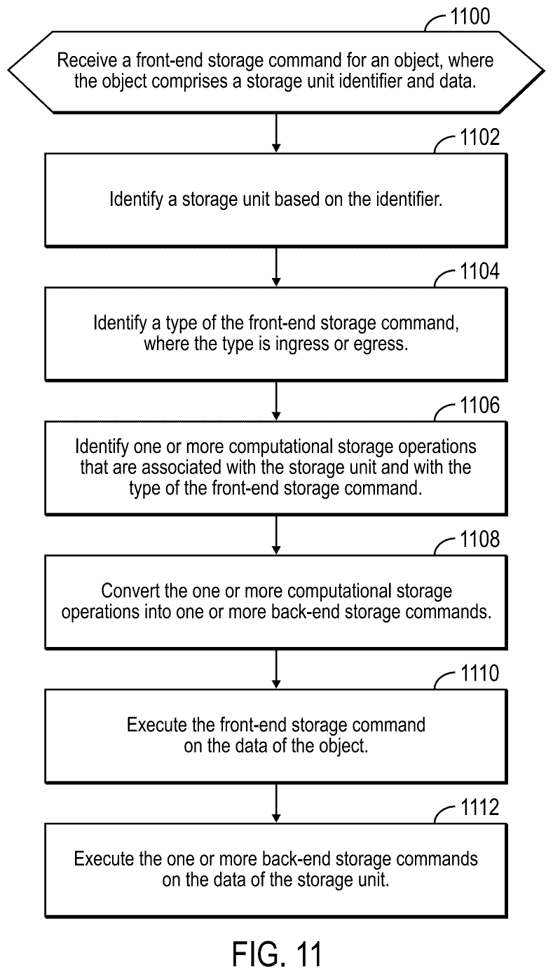

FIG. 11 illustrates, in a flowchart, operations for identifying and executing computational storage operations in accordance with certain embodiments. Control begins at block 1100 with the operation compute logic 205 receiving a front-end storage command for an object, where the object comprises a storage unit identifier and data.

In block 1102, the operation compute logic 205 identifies a storage unit based on the identifier. In block 1104, the operation compute logic 205 identifies a type of the front-end storage command, where the type is ingress or egress. In block 1106, the operation compute logic 205 identifies one or more computational storage operations that are associated with the storage unit and with the type of the front-end storage command.

In block 1108, the operation compute logic 205 converts the one or more computational storage operations into one or more back-end storage commands. In block 1110, the operation compute logic 205 executes the front-end storage command s on the data of the object. In block 1112, the operation compute logic 205 executes the one or more back-end storage commands on the data of the storage unit (e.g., to derive new data).

In certain embodiments, the storage unit identifier is selected from a group consisting of a bucket, a key, a range, a file directory, and a database table.

In certain embodiments, in response to the front-end storage command comprising an ingress operation, the operation compute logic 205 identifies the one or more computational storage operations that are associated with the storage unit and with the ingress operation. In certain embodiments, in response to the front-end storage command comprising an egress operation, the operation compute logic 205 identifies the one or more computational storage operations that are associated with the storage unit and with the egress operation.

In certain embodiments, the operation compute logic 205 identifies a trigger operation, identifies one or more new computational storage operations that are associated with the storage unit and with the trigger operation, converts the one or more new computational storage operations into one or more new back-end storage commands, and executes the one or more new back-end storage commands.

In certain embodiments, the operation compute logic 205 receives a read front-end storage command for the storage unit and returns data stored in the storage unit, including new data derived by executing the one or more back-end storage commands.

In certain embodiments, for the storage unit, a first set of computational storage operations is associated with an ingress operation, a second set of computational storage operations is associated with an egress operation, and a third set of computational storage operations is associated with a trigger operation. In various embodiments, each set of computational storage operations may include different computational storage operations, the same computational storage operations or some same and some different computational storage operations.

In certain embodiments, the one or more computational storage operations that are associated with the storage unit modify data of other objects in the storage unit.

In certain embodiments, storage command semantics on a front-end storage interface (i.e., a legacy client storage interface) are overloaded.

In certain embodiments, the computer processor comprises a Graphics Processing Units (GPU).

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product, the computer program product comprising a computer readable storage medium having program instructions embodied therewith, the program instructions executable by a computer processor to cause the computer processor to perform operations comprising:
receiving a front-end storage command for an object, wherein the object comprises a storage unit identifier and data;
identifying a storage unit based on the identifier;
identifying one or more computational storage operations that are associated with the storage unit and with a type of the front-end storage command;
converting the one or more computational storage operations into one or more back-end storage commands; and
executing the front-end storage command and the one or more backend storage commands.

2. The computer program product of claim 1, wherein the storage unit identifier is selected from a group consisting of a bucket, a key, a range, a file directory, and a database table.

3. The computer program product of claim 1, wherein the program instructions are executable by the computer processor to cause the computer processor to perform further operations comprising:
in response to the type of the front-end storage command comprising an ingress operation, identifying the one or more computational storage operations that are associated with the storage unit and with the ingress operation; and
in response to the type of the front-end storage command comprising an egress operation, identifying the one or more computational storage operations that are associated with the storage unit and with the egress operation.

4. The computer program product of claim 1, wherein the program instructions are executable by the computer processor to cause the computer processor to perform further operations comprising:
identifying a trigger operation;
identifying one or more new computational storage operations that are associated with the storage unit and with the trigger operation;
converting the one or more new computational storage operations into one or more new back-end storage commands; and
executing the one or more new back-end storage commands.

5. The computer program product of claim 1, wherein the program instructions are executable by the computer processor to cause the computer processor to perform further operations comprising:
receiving a read front-end storage command for the storage unit; and
returning data stored in the storage unit, including new data derived by executing the one or more back-end storage commands.

6. The computer program product of claim 1, wherein the one or more computational storage operations that are associated with the storage unit modify data of other objects in the storage unit.

7. The computer program product of claim 1, wherein storage command semantics on a front-end storage interface are overloaded.

8. A computer system, comprising:
one or more computer processors, one or more computer-readable memories and one or more computer-readable, tangible storage devices; and
program instructions, stored on at least one of the one or more computer-readable, tangible storage devices for execution by at least one of the one or more computer processors via at least one of the one or more computer-readable memories, to perform operations comprising:
receiving a front-end storage command for an object, wherein the object comprises a storage unit identifier and data;
identifying a storage unit based on the identifier;
identifying one or more computational storage operations that are associated with the storage unit and with a type of the front-end storage command;
converting the one or more computational storage operations into one or more back-end storage commands; and
executing the front-end storage command and the one or more backend storage commands.

9. The computer system of claim 8, wherein the storage unit identifier is selected from a group consisting of a bucket, a key, a range, a file directory, and a database table.

10. The computer system of claim 8, wherein the operations further comprise:
in response to the type of the front-end storage command comprising an ingress operation, identifying the one or more computational storage operations that are associated with the storage unit and with the ingress operation; and
in response to the type of the front-end storage command comprising an egress operation, identifying the one or more computational storage operations that are associated with the storage unit and with the egress operation.

11. The computer system of claim 8, wherein the operations further comprise:
identifying a trigger operation;
identifying one or more new computational storage operations that are associated with the storage unit and with the trigger operation;
converting the one or more new computational storage operations into one or more new back-end storage commands; and
executing the one or more new back-end storage commands.

12. The computer system of claim 8, wherein the operations further comprise:
receiving a read front-end storage command for the storage unit; and
returning data stored in the storage unit, including new data derived by executing the one or more back-end storage commands.

13. The computer system of claim 8, wherein the one or more computational storage operations that are associated with the storage unit modify data of other objects in the storage unit.

14. The computer system of claim 8, wherein the computer processor comprises a Graphics Processing Units (GPU).

15. A computer-implemented method, comprising operations for:
receiving a front-end storage command for an object, wherein the object comprises a storage unit identifier and data;
identifying a storage unit based on the identifier;
identifying one or more computational storage operations that are associated with the storage unit and with a type of the front-end storage command;
converting the one or more computational storage operations into one or more back-end storage commands; and
executing the front-end storage command and the one or more backend storage commands.

16. The computer-implemented method of claim 15, wherein the storage unit identifier is selected from a group consisting of a bucket, a key, a range, a file directory, and a database table.

17. The computer-implemented method of claim 15, further comprising operations for:
in response to the type of the front-end storage command comprising an ingress operation, identifying the one or more computational storage operations that are associated with the storage unit and with the ingress operation; and
in response to the type of the front-end storage command comprising an egress operation, identifying the one or more computational storage operations that are associated with the storage unit and with the egress operation.

18. The computer-implemented method of claim 15, further comprising operations for:
identifying a trigger operation;
identifying one or more new computational storage operations that are associated with the storage unit and with the trigger operation;
converting the one or more new computational storage operations into one or more new back-end storage commands; and
executing the one or more new back-end storage commands.

19. The computer-implemented method of claim 15, further comprising operations for:
receiving a read front-end storage command for the storage unit; and
returning data stored in the storage unit, including new data derived by executing the one or more back-end storage commands.

20. The computer-implemented method of claim 15, wherein the one or more computational storage operations that are associated with the storage unit modify data of other objects in the storage unit.
